(19) United States
(12) Patent Application Publication
(10) Pub. No.: US 2024/0356601 A1
(43) Pub. Date: Oct. 24, 2024

(54) Method for Communicating by Means of a Multi-Antenna Arrangement Designed for Directional Transmission, and Communication Device

(71) Applicant: Siemens Aktiengesellschaft, München (DE)

(72) Inventor: Rainer Falk, Erding (DE)

(73) Assignee: Siemens Aktiengesellschaft, München (DE)

(21) Appl. No.: 18/687,524

(22) PCT Filed: Aug. 29, 2022
(86) PCT No.: PCT/EP2022/073947

§ 371 Date: Feb. 28, 2024

(30) Foreign Application Priority Data
Aug. 31, 2021 (DE) 10 2021 209 536.4

(51) Int. Cl. H04B 7/06; H04W 12/106; H04W 12/122

(52) U.S. Cl. CPC H04B 7/0617; H04W 12/106; H04W 12/122

(57) ABSTRACT

Various embodiments of the teachings herein include methods for communicating with two or more communication partners using a multi-antenna arrangement designed for directional transmission. An example method includes: operating the multi-antenna arrangement using directional transmission parameters; limiting the directional transmission for parameters a particular communication partner to a subset of the directional transmission parameters, the subset depending on the particular communication partner; and determining the subset by transmitting a cryptographically protected pilot signal from the communication partner.

### CROSS-REFERENCE TO RELATED APPLICATIONS

This application is a U.S. National Stage Application of International Application No. PCT/EP2022/073947 filed Aug. 29, 2022, which designates the United States of America, and claims priority to DE Application No. 10 2021 209 536.4 filed Aug. 31, 2021, the contents of which are hereby incorporated by reference in their entirety.

### TECHNICAL FIELD

The present disclosure relates to communications. Various embodiments of the teachings herein include systems and/or methods for communicating by means of a multi-antenna arrangement designed for directional transmission and communication devices.

### BACKGROUND

In modern radio transmission systems, in particular in 5G and WLAN radio transmission systems, multi-antenna arrangements are regularly used in order to produce a directional effect, also referred to as beamforming, during the radio transmission. Multi-antenna systems are also referred to as MIMO (Multiple Input, Multiple Output) antenna systems. The directional effect arises as a result of the signals of the individual antennas being able to be actuated in phase-shifted fashion, that is to say with a time offset among one another, and with different signal levels. This can be expressed by multiplying a complex transmission signal by complex filter coefficients, for example. Such filter coefficients form directional transmission parameters and are typically determined adaptively. This can be accomplished using so-called pilot signals in order to measure the characteristic of the transmission channel, here the transmission link.

The reliability of communication with remote communication partners by means of multi-antenna arrangements depends on correct determination of the directional transmission parameters. The transmission properties are impaired otherwise. In particular, the available transmission capacity during communication using multi-antenna arrangements can be reduced as a result of spatial separation of communication signals from different communication partners not being possible or being restricted during communication. This circumstance sets up attack scenarios, which reduce the immunity of a communication using multi-antenna arrangements. In particular manipulation or disruption of the measurement of the properties of the transmission channel for the purpose of determining or adapting the directional transmission parameters facilitates a denial of service attack on a mobile radio system.

### SUMMARY

There is thus a need to determine directional transmission parameters for dynamically adapting and reconfiguring a transmission by means of multi-antenna arrangements in a manner protected against manipulation. The teachings of the present disclosure include improved methods for communicating by means of a multi-antenna arrangement designed for directional transmission that is in particular more robust toward attacks to reduce transmission efficiency. For example, some embodiments include a method for communicating with at least two or more communication partners (UE) by means of a multi-antenna arrangement designed for, in particular digital, directional transmission, in which the multi-antenna arrangement (AS) is operated using directional transmission parameters (PP) and in which only a subset (DRPWL) of the directional transmission parameters (PP), which is dependent on the communication partner (UE), is permitted for communication with one of the communication partners (UE).

In some embodiments, the directional transmission parameters, in particular the subset (DRPWL), are formed for the purpose of actuating the multi-antenna arrangement (AS) to send communication signals directionally to or produce direction-dependent sensitivity in the multi-antenna arrangement (AS).

In some embodiments, the directional transmission parameters form beamforming parameters and/or directional sensitivity parameters.

In some embodiments, the multi-antenna arrangement (AS) forms a radio antenna arrangement.

In some embodiments, the subset (DRPWL) of directional transmission parameters is ascertained by transmitting at least one pilot signal.

In some embodiments, at least one pilot signal is cryptographically protected, in particular integrity protected and/or authenticated and/or encrypted.

In some embodiments, the subset (DRPWL) has been or is firmly predefined or is selected on the basis of a relative position in relation to the communication partner (UE) or on the basis of context information.

In some embodiments, the subset (DRPWL) is determined by means of a reference measurement, preferably in advance.

As another example, some embodiments include a communication device having a multi-antenna arrangement (AS) designed for, in particular digital, directional transmission, which includes a selection unit (PPWC) designed and configured to permit only a subset (DRPWL) of the directional transmission parameters, which is dependent on a communication partner (UE) of the communication device.

In some embodiments, the communication device forms a transmission device and/or a reception device.

### BRIEF DESCRIPTION OF THE DRAWINGS

The teachings of the present disclosure are explained in more detail below on the basis of exemplary embodiments depicted in the drawings, in which:

FIG. 1 shows a basic schematic diagram of a wireless communication network with an example communication device incorporating teachings of the present disclosure when an example method incorporating teachings of the present disclosure for communication by means of a multi-antenna arrangement is performed;

FIG. 2 shows a basic schematic diagram of an example method incorporating teachings of the present disclosure for communication by means of a multi-antenna arrangement as shown in FIG. 1; and

FIG. 3 shows a basic schematic diagram of an example method incorporating teachings of the present disclosure for communication by means of a multi-antenna arrangement.

### DETAILED DESCRIPTION

Some embodiments of the teachings herein include methods for communicating with at least two or more communication partners by means of a multi-antenna arrangement designed for, in particular digital, directional transmission involves the multi-antenna arrangement being operated using directional transmission parameters and only a subset of the directional transmission parameters, which is dependent on the communication partner, being permitted for communication with one of the communication partners. The subset of the directional transmission parameters is a genuine subset, a genuine partial set, of the directional transmission parameters, which is smaller than the set of directional transmission parameters that are technically possible.

Directional parameters that are technically possible are thus not permitted depending on the respective communication partner.

The expression “the multi-antenna arrangement is operated using directional transmission parameters” is understood within the context of the present application to mean that the multi-antenna arrangement is actuated for directional communication by means of the directional transmission parameters, a transmission signal intended for transmission is modified by means of the directional transmission parameters when being sent. In some embodiments, the transmission signal is available as a complex value and the directional transmission parameters form a respective complex factor for each transmitter of the multi-antenna arrangement, by which factor the transmission signal is multiplied before being sent using the respective transmitter. In some embodiments, the directional transmission parameters are beamforming parameters and/or directional sensitivity parameters, that is to say parameters by which the individual signals received by individual antennas of the multi-antenna arrangement are modified, in particular multiplied, when a transmission signal is received.

In some embodiments, the multi-antenna arrangement is a one-dimensional array arrangement or a two-dimensional matrix arrangement. Directional communication by means of the multi-antenna arrangement can easily be achieved in this arrangement.

In some embodiments, the method involves the directional transmission parameters being formed or selected for the purpose of actuating the multi-antenna arrangement to send communication signals directionally or to receive communication signals in a direction-dependent manner. This allows communication with communication partners located in different spatial directions by means of communication signals at the same frequency, since the communication signals do not overlap spatially on account of the different spatial directions.

In some embodiments, the method involves the directional transmission parameters forming beamforming parameters and/or directional sensitivity parameters. Beamforming parameters or directional sensitivity parameters can be used in a manner known per se to easily bring about directional communication by means of communication signals sent directionally or received in a directionally sensitive manner.

In some embodiments, the method involves the multi-antenna arrangement forming a radio antenna arrangement. Particularly in frequencies, utilization the range radio of optimum of transmission capacities is advantageous. In this development, spatially separate, repeated use of the same radio frequency, that is to say so-called “spatial reuse”, is possible. In this development, the method allows the possibility of such spatially separate, repeated use of the same radio frequency to be maintained, since known attack scenarios can easily be thwarted by means of the methods described herein.

In some embodiments, the subset of directional transmission parameters is ascertained by transmitting at least one pilot signal. A pilot signal can be used to easily measure directional transmission parameters in a manner known per se. In this development, a subset of directional transmission parameters suitable for transmission can therefore easily be ascertained. Other measures, applied as described below, can also be used to easily determine or agree on the subset of the directional transmission parameters. In the simplest case, a subset of the directional transmission parameters suitable for transmission can easily be determined or arranged by adding another, protected transmission channel.

In some embodiments, the method involves the at least one pilot channel being cryptographically protected, in particular integrity protected and/or authenticated and/or encrypted. This allows an attack on the pilot signal and therefore on the communication by means of the multi-antenna arrangement to be effectively thwarted, since the cryptographically protected pilot signal significantly hampers simulation of a pilot signal or disruption of an authentic pilot signal by unauthorized attackers.

Fittingly, the method involves the subset for a communication partner being firmly predefined or being selected on the basis of a relative position in relation to the communication partner or on the basis of context information. If the subset is firmly predefined, there is no longer a need for manipulation-proof determination of the respective subset when the method is carried out. If the subset is selected on the basis of a relative position in relation to the communication partner, the subset can be limited to directional transmission parameters that facilitate optimum communication with the communication partner. Furthermore, taking account of context information allows suitable directional transmission parameters to be selected under the constraint of a context that the context information specifies. Usefully, weather conditions are contexts that can influence or disrupt the conditions for communication by means of multi-antenna arrangements.

In some embodiments, the subset is determined by means of a reference measurement, e.g. in advance. This allows the method to be performed in a particularly resource-saving manner. As such, a subset of directional transmission parameters can be ascertained by means of a reference measurement using communication partners that are suitably technically equipped for reference measurement. Later use of the subset then merely requires communication partners that are set up for communication. The reference measurement itself does not require the communication partners to be equipped further at this time, i.e. different communication partners can be used for the actual communication and for the reference measurement.

An example communication device incorporating teachings of the present disclosure comprises a multi-antenna arrangement for, in particular digital, directional transmission, in particular for beamforming, and includes a selection unit designed and configured to permit a subset of the directional transmission parameters, said permission being dependent on a communication partner of the communication device. The communication device can be used to perform one or more of the methods described herein. As already explained for the methods, the subset is a genuine partial set of the directional transmission parameters.

In some embodiments, the communication device forms a transmission device and/or a reception device. The method can be employed both for a transmission device and for a reception device. In some embodiments, the communication device is both in the form of a transmission device and in the form of a reception device. In some embodiments, however, the device can also be used for a unidirectional transmission and the communication device is designed for unidirectional transmission.

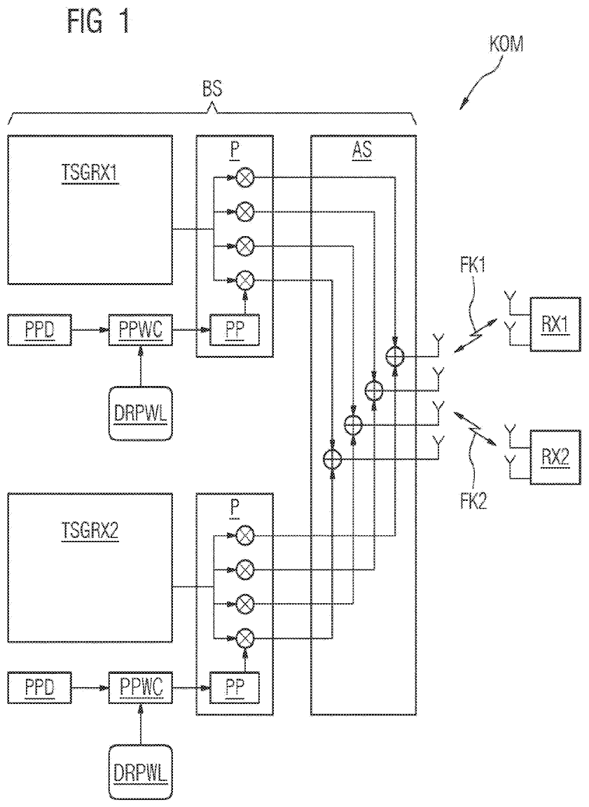

The communication network KOM depicted in FIG. 1 includes a base station BS and two mobile subscribers RX1, RX2 of the communication network KOM, which are in the form of autonomous transport vehicles, also known as AGVs (Automated Guided Vehicle), in the exemplary embodiment depicted. The mobile subscribers RX1, RX2 are also referred to by the reference sign UE in drawings 2 and 3.

The mobile subscribers RX1, RX2 each comprise a transmission and reception device for wireless radio communication with the base station. The base station BS likewise comprises a transmission and reception device and communicates with each of the mobile subscribers RX1, RX2 in pairs by radio, using a 5G mobile radio frequency in the exemplary embodiment depicted. The transmission and reception devices of the mobile subscribers RX1, RX2 and the transmission and reception device of the base station BS are each formed by a multi-antenna arrangement, in each case a MIMO multi-antenna system in the exemplary embodiment depicted. The multi-antenna arrangements are each operated by means of directional transmission parameters, with the result that the multi-antenna arrangement can send radio signals directionally and can receive radio signals in a directionally sensitive manner. The directional transmission parameters form filter coefficients for the respective MIMO multi-antenna system.

The respective mobile subscribers RX1, RX2 and the base station BS are designed for in each case bidirectional radio communication with one another and can transmit signaling messages and/or payload data, for example, to one another. The mobile subscribers RX1, RX2 and the base station BS take their respective relative position in relation to one another as a basis for dynamically determining their respective directional transmission parameters and as such continuously or repeatedly adapt the direction of their radio transmission. To this end, pilot signals can be transmitted between the base station BS and the mobile subscribers RX1, RX2, said pilot signals being able to be used by the respective receiver, as a result of evaluation of the received pilot signal, to determine directional transmission parameters on the basis of properties of the respective transmission channel FK1, FK2, which are then able to be used for transmitting the actual payload data.

In the exemplary embodiment depicted in FIG. 1, the base station BS includes, for the purpose of performing an example method incorporating teachings of the present disclosure, a transmission and reception device having a multi-antenna arrangement AS with four radio antennas. In other exemplary embodiments, not depicted specifically, which otherwise correspond to the exemplary embodiment depicted, the multi-antenna arrangement AS may also comprise a different number of radio antennas, for example 128 or 1024 radio antennas, which are arranged in a matrix shape, for example. The transmission signals TSGRX1, TSGRX2 of the base station BS for mobile subscribers RX1, RX2 are each multiplied by a radio-antenna-specific pre-coding parameter PP in a pre-coding device P.

The pre-coding parameters PP form the previously explained directional transmission parameters and can be formulated as complex pre-coding parameters PP when the radio communication is described by means of complex radio signals. The pre-coding parameters PP thus have an amplitude and a phase. In some embodiments, the pre-coding parameters PP can be described using an inphase component and a quadrature component. By means of the actuation of the radio antennas with the transmission signal modified by the directional transmission parameters, the radio antennas of the multi-antenna arrangement AS radiate to different mobile subscribers RX1, RX2 with a directional effect. The base station BS selects different pre-coding parameters PP for different mobile subscribers, here for the two mobile subscribers RX1, RX2. The transmission signals for the two mobile subscribers RX1, RX2 are added and collectively sent.

The two mobile subscribers RX1, RX2 likewise produce a directional effect as a result of an appropriate arrangement of their radio antennas in their transmission and reception device. In the exemplary embodiment depicted, the mobile subscribers RX1, RX2 each comprise transmission and reception devices having two radio antennas. In principle, other exemplary embodiments, which are not depicted specifically, may also contain more radio antennas. In other exemplary embodiments, not depicted specifically, the mobile subscribers RX1, RX2 may each be designed for simultaneous radio communication with more than two base stations BS and may consequently use multiple directional transmission parameters for reception.

In the case of a bidirectional transmission, the transmission and reception devices act both as a transmission device and as a reception device, and therefore as a transceiver. In principle, the same radio antennas of the antenna arrangement AS are used both for sending and for receiving. As such, the transmission and reception devices can each evaluate pilot signals or other applicable check signals in order to dynamically determine the directional transmission parameters. To determine the directional transmission parameters in a determination step DETCPSGP, different algorithms and methods can be used in principle, for example using pilot signals. The same applies to the reception end, at which applicable directional transmission parameters for the radio antennas are likewise determined.

The present disclosure addresses the problem that the determination of the pre-coding parameters PP can, in principle, be manipulated by a jamming transmitter. Such a jamming transmitter could affect the use of the communication network KOM by interfering with those pilot signals that are used for determining the pre-coding parameters PP. This could decouple the mobile subscribers RX1, RX2 from the base station BS. The capacity of the communication system KOM would be massively reduced as a result, since “spatial reuse”, i.e. “space division multiple access”, would no longer work as intended.

To this end, the methods and/or systems incorporating the teachings herein employ a monitoring unit PPWC that verifies the directional transmission parameters PPD. This is accomplished by using a directional transmission parameter whitelist DRPWL that defines permissible sets of directional transmission parameters. A determined set of directional transmission parameters PPD is actually used only if it is permissible according to the directional transmission parameter whitelist DRPWL. As depicted in FIG. 1, the directional transmission parameter whitelist DRPWL is held in the base station. The directional transmission parameter whitelist DRPWL is used to verify and filter the directional transmission parameters PPD by means of the monitoring unit PPWC, with the result that only directional transmission parameters on the directional transmission parameter whitelist DRPWL continue to be used.

By way of example, the directional transmission parameter whitelist DRPWL is determined and firmly configured administratively, for instance while the communication network KOM is being commissioned or the base station BS and the mobile subscribers RX1, RX2 are being started up. In another exemplary embodiment, which is not depicted specifically, the propagation conditions in an intended environment can alternatively be simulated, the directional transmission parameter whitelist DRPWL being determined by way of a simulation.

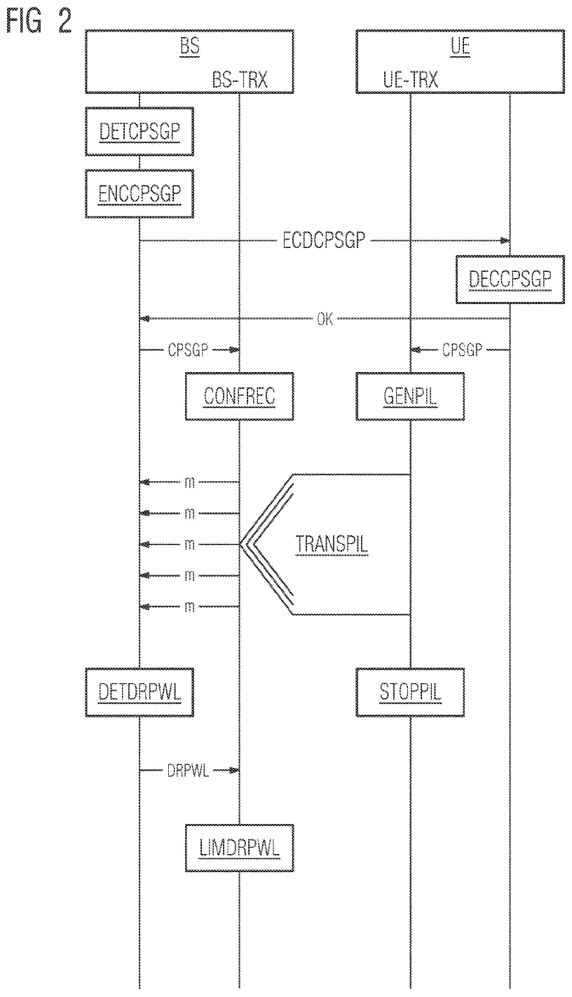

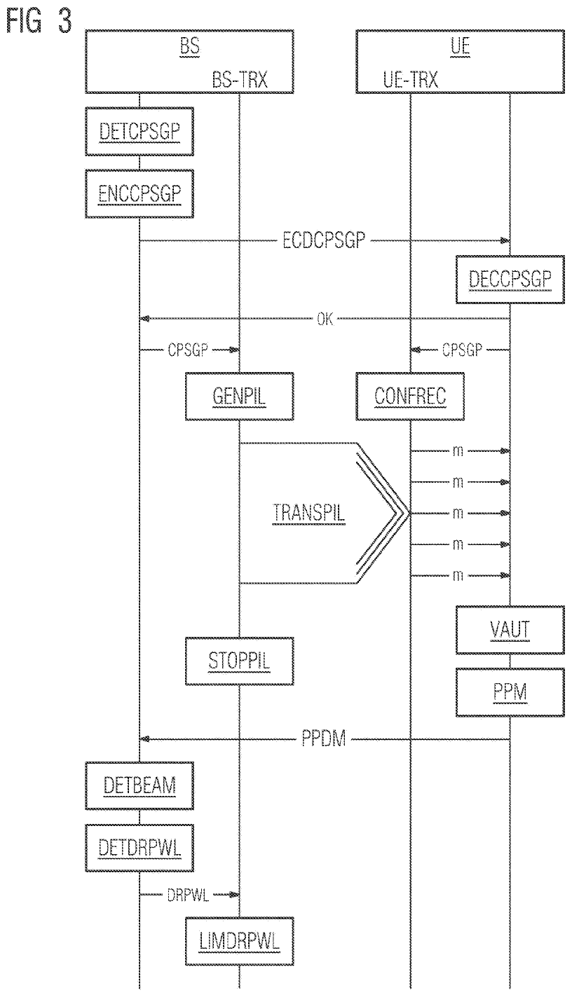

In some embodiments, e.g., those depicted in FIGS. 2 and 3, cryptographically protected pilot signals or measurement signals are used in order to determine the directional transmission parameter whitelist in DRPWL a manner protected against manipulation and therefore in a trusted manner. This is accomplished using pilot signals that include a cryptographic authentication code or that are cryptographically generated. The pilot signals can be cryptographically generated using a cryptographic pseudorandom noise code generator, for example. The transmission and reception devices can authenticate themselves bidirectionally via a signaling channel or a user data channel and can agree on the directional transmission parameters of the pilot signal to be used in a cryptographically protected, here encrypted, authenticated and integrity-protected manner.

In a 5G/6G mobile radio system, a pilot signal, sometimes also referred to as an SSBB (Synchronization Signal Block Beam), may include a cryptographically protected or cryptographically formed physical layer authentication code. This allows the mobile subscriber RX1, RX2 to verify whether an identified radio beam is actually an original beam from the base station BS.

The representation shows a possible sequence in which a cryptographically protected pilot signal is used to determine the direction transmission parameter whitelist DRPWL in a manner protected against manipulation and to set it up in the base station BS. In the example depicted, the invention is implemented by the base station BS. In FIGS. 2 and 3, the method is explained on the basis of only a single mobile subscriber RX1, RX2, which is depicted as the mobile subscriber UE in the drawing. Independently of the sole depiction of the methods on the basis of the base station BS, the methods can be employed in corresponding fashion at the mobile subscriber UE. In principle, the methods can be simultaneously carried out both at the base station BS and at the mobile subscriber UE.

As depicted in FIG. 2, the base station BS uses a determination step DETCPSGP to determine cryptographic generation parameters CPSGP, which can be used in a manner known per se to generate a cryptographically protected pilot signal. The base station BS uses an encryption step ENCPSGP to encrypt the cryptographic generation parameters to produce encrypted cryptographic generation parameters ECDCPSGP. The encrypted cryptographic generation parameters ECDCPSGP are sent to the mobile subscriber UE, which decrypts the encrypted cryptographic generation parameters ECDCPSGP in a decryption step DECCPSGP. The mobile subscriber UE can then use a generation step GENPIL to generate a cryptographically protected pilot signal by means of the decrypted cryptographic generation parameters CPSGP.

The base station BS uses a configuration step CONFREC to configure its transmission and reception device to receive the cryptographically protected pilot signal. In a step TRANSPIL, the cryptographically protected pilot signal is sent from the mobile subscriber UE to the base station BS. By way of example, the cryptographically protected pilot signal may be a cryptographically protected spread code signal that is formed by means of a cryptographically generated pseudorandom noise signal and sent or received and evaluated. The cryptographically generated pseudorandom noise signal can also be referred to as a cryptographic spread code signal. Furthermore, it is possible for the pilot signal to have a cryptographically generated physical layer authentication tag or a cryptographically generated symbol sequence of physical layer transmission symbols.

The base station BS receives the cryptographically protected pilot signal and undertakes a series of measurements m on the cryptographically protected pilot signal in order to ascertain from the pilot signal the directional transmission parameters to be permitted for the further radio communication. These directional transmission parameters are stored by the base station BS in a directional transmission parameter whitelist DRPWL. If the base station BS had enough time available to carry out the measurements m, the mobile subscriber UE uses a transmit stop STOPPIL to terminate the sending of the pilot signal.

The base station BS subsequently uses the directional transmission parameters on the directional transmission parameter whitelist DRPWL. By limiting LIMDRPWL, for example by means of the monitoring unit PPWC, the directional transmission parameters to such transmission parameters on the directional transmission parameter whitelist DRPWL, the base station BS can then actuate its transmission and reception device BS-TRX for radio communication in a manner protected against manipulation.

The same method can be performed by the mobile subscriber and the base station with reciprocally swapped roles at the same time, and so the base station BS can actuate its transmission and reception device BS-TRX and the mobile subscriber UE can actuate its transmission and reception device UE-TRX by means of a directional transmission parameter whitelist DRPWL.

In some embodiments, the directional transmission parameter whitelist DRPWL is determined in a manner protected against manipulation by using a first mobile subscriber UE and configured for a second mobile subscriber UE. This has the advantage that the specific determination of the radio parameter whitelist DRPWL in a manner protected against manipulation does not have to be implemented on all mobile subscribers UE. The directional transmission parameter whitelist DRPWL determined for a specific situation, for example a position of the mobile subscriber UE or prevailing weather conditions, can then be configured for a mobile subscriber UE that is in the applicable situation.

FIG. 3 shows another exemplary embodiment, in which the mobile subscriber UE does not send the pilot signal, but rather the base station BS sends multiple pilot signals, which are each associated with a dedicated radio beam, in a step TRANSPIL. One pilot signal contains respective identification information, for example radio beam identification information or physical radio cell identification information, and additionally a cryptographically protected or cryptographically formed physical layer authentication code.

Unlike in the embodiment shown in FIG. 2, the mobile subscriber UE uses a configuration step CONFREC to configure its transmission and reception device UE-TRX to receive the cryptographically protected pilot signal. The mobile subscriber UE uses multiple measurements m to verify the authentication codes contained in the pilot signals. The mobile subscriber UE sends preprocessed measurement results PPDM to the base station BS. The base station BS takes the preprocessed measurement results PPDM as a basis for selecting a radio beam in a selection step DETBEAM and ascertains the directional transmission parameters belonging to this radio beam in a selection step DETDRPWL and incorporates these directional transmission parameters into a directional transmission parameter whitelist DRPWL.

By limiting LIMDRPWL, for example by means of the monitoring unit PPWC, the directional transmission parameters on the directional transmission parameter whitelist DRPWL, the base station BS can actuate its transmission and reception device BS-TRX in a manner protected against manipulation and therefore communicate with the mobile subscriber UE by means of radio communication in a manner secure from attack. In some embodiments, the mobile subscriber UE itself could also select a radio beam and the base station BS could transfer information relating to the selected radio beam.

What is claimed is:

1. A method for communicating with two or more communication partners using a multi-antenna arrangement designed for directional transmission, the method comprising:
operating the multi-antenna arrangement using directional transmission parameters;
limiting the directional transmission parameters for a particular communication partner to a subset of the directional transmission parameters, the subset depending on the particular communication partner; and
determining the subset by transmitting a cryptographically protected pilot signal from the communication partner.

2. The method as claimed in claim 1, wherein the directional transmission parameters cause the multi-antenna arrangement to send communication signals directionally or to produce direction-dependent sensitivity in the multi-antenna arrangement.

3. The method as claimed in claim 1, wherein the directional transmission parameters include beamforming parameters and/or directional sensitivity parameters.

4. The method as claimed in claim 1, wherein the multi-antenna arrangement comprises a radio antenna arrangement.

5-6. (canceled)

7. The method as claimed in claim 1, wherein the subset is predefined on the basis of a relative position in relation to the communication partner or on the basis of context information.

8. The method as claimed in claim 1, wherein the subset is determined by a reference measurement.

9. A communication device comprising:
a multi-antenna arrangement designed for directional transmission;
a selection unit to permit only a subset of the directional transmission parameters dependent on a communication partner of the communication device.

10. The communication device as claimed in claim 9, the communication device comprising a transmission device and/or a reception device.
